(19) United States
(12) Patent Application Publication
(10) Pub. No.: US 2006/0203630 A1
(43) Pub. Date: Sep. 14, 2006

(54) Information storage medium and method of recording and/or reproducing data on and/or from the same

(75) Inventors: Kyung-geun Lee, Gyeonggi-do (KR); Tae-kyung Kim, Seoul (KR); Tatsuhiro Otsuka, Gyeonggi-do (KR); Wook-yeon Hwang, Gyeonggi-do (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/430,895

(22) Filed: May 10, 2006

Related U.S. Application Data
(63) Continuation of application No. 10/848,585, filed on May 19, 2004.
(60) Provisional application No. 60/485,157, filed on Jul. 8, 2003.

(30) Foreign Application Priority Data
May 20, 2003 (KR) 2003-32092

(51) Int. Cl. G11B 7/00

(52) U.S. Cl. 369/44.25

(57) ABSTRACT

An information storage medium and a method of recording data on and/or reproducing data from the information storage medium, includes an information storage medium having at least one information storage layer. Data is recorded in the form of protruding or indented pits in the entire or partial area of the information storage medium, and information regarding the protruding or indented pits is recorded. Smooth tracking can be achieved using the information regarding the protruding or indented pits, that is, push-pull polarity information.

### CROSS-REFERENCE TO RELATED APPLICATIONS

This application is a continuation of U.S. patent application Ser. No. 10/848,585, filed May 19, 2004, now pending, which claims the benefit of Korean Patent Application No. 2003-32092, filed on May 20, 2003, in the Korean Intellectual Property Office, and the benefit of U.S. Provisional Patent Application No. 60/485,157, filed on Jul. 8, 2003, in the U.S. Patent and Trademark Office, the disclosures of which are incorporated herein by reference.

### BACKGROUND OF THE INVENTION

1. Field of the Invention

The present invention relates to an optical information storage medium on which tracking polarity data corresponding to the form of pits is recorded, and a method of recording and/or reproducing data on and/or from the optical information storage medium.

2. Description of the Related Art

General optical disks, which are optical information storage media, are classified as compact disks (CDs) or digital versatile disks (DVDs) according to their information storage capacity. The optical disks may also be classified as mini disks (MDs) with diameters of 65 mm or less. Furthermore, disks having a recording capacity of 20GB or greater are under development.

The optical disks may be further classified as read-only disks or rewritable disks. Examples of the read-only disks are CD-ROM (read only memory) and DVD-ROM. Examples of rewritable disks are CD±R/RW, DVD±R/RW, and DVD-RAM (random access memory). CD-R and DVD-R can perform recording only once, CD-RW and DVD-RW can perform recording and/or reproduction about 1000 times, and DVD-RAM can perform recording and/or reproduction several hundreds of thousands of times.

In general, data is recorded as pits on reproduction-only disks or read-only disks. Since rewritable disks are coated with a phase changing material, data is recorded thereon according to a phase change.

In an apparatus for recording and/or reproducing data on and/or from an optical disc, a pickup accurately follows a track on which user data has been recorded and receives a laser beam reflected from the track, thereby reading the user data. A signal used when the pickup follows the track is referred to as a tracking signal. The tracking signal is obtained from a photo diode having a plurality of receiving portions, which receive a laser beam and adds or subtracts signals obtained from light received by the individual receiving portions. The tracking signal is shaped in an S-letter curve in which the left and right polarities are opposite to each other around its center.

The tracking signal has different polarities depending on the type of optical disk, that is, the physical characteristics of a recording layer, for example, the physical shape of a pit, the physical shape of a track, and the like. For example, FIGS. 1A and 1B show groove tracks G and land tracks L arranged in opposite ways. In FIG. 1A, a tracking signal has a polarity that changes from (+) to (−). In FIG. 1B, the tracking signal has a polarity that changes from (−) to (+). As described above, the polarity of a tracking signal is classified as a polarity changing from (−) to (+) or a polarity changing from (+) to (−). A tracking signal is differently processed depending on the polarity of the tracking signal. Hence, if the polarity of a tracking signal is wrongly recognized, data may not be properly reproduced. Accordingly, when an optical disk is loaded, a conventional recording and/or reproducing apparatus recognizes the polarity of a tracking signal through trial and error and then follows a track on which user data has been recorded, based on the information about the recognized polarity. In this way, the user data is read from the optical disk.

Thus, the conventional reproducing apparatus spends some time obtaining information about the polarity of a tracking signal before reading out user data. This impedes immediate reproduction of user data.

The polarity of a tracking signal can be changed by the physical shape of a pit. The physical shape of a pit may be different depending on the type of disk. However, in the related art, extra information about the polarity of a tracking signal depending on the physical shape of a pit is not recorded on a disk, so that the reliability of data recording and/or reproduction is degraded. Also, the conventional reproducing apparatus spends some time obtaining information about the polarity of a tracking signal through trial and error, delaying recording and/or reproduction.

### SUMMARY OF THE INVENTION

The present invention provides an optical information storage medium on which information about a tracking polarity depending on a pit shape, particularly, information about a push-pull polarity, has been recorded, and a method of recording and/or reproducing data on and/or from the optical information storage medium.

According to an aspect of the present invention, there is provided an information storage medium having at least one information storage layer, wherein data is recorded in the form of protruding or indented pits in the entire or partial area of the information storage medium, and information regarding the protruding or indented pits is recorded.

According to an aspect of the present invention, the information regarding the protruding or indented pits is push-pull polarity information.

According to an aspect of the present invention, the information regarding the protruding or indented pits is recorded in or in front of a frame sync.

According to an aspect of the present invention, the information storage medium includes a burst cutting area (BCA) and a lead-in area, one of which stores the information regarding the protruding or indented pits.

According to an aspect of the present invention, the protruding or indented pits may be wobbling pits.

According to an aspect of the present invention, data is decoded by performing an exclusive OR operation with respect to the push-pull polarity information and data reproduced from the protruding or indented pits.

According to another aspect of the present invention, there is provided a method of recording data on and/or reproducing data from an information storage medium having at least one information storage layer, the method including recording data in the form of protruding or indented pits in the entire or partial area of the information storage medium and recording information regarding the protruding or indented pits.

This method further includes reproducing the push-pull polarity information and recording data on or reproducing data from the information storage medium by performing tracking on the basis of the reproduced push-pull polarity information.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and advantages of the present invention will become more apparent by describing in detail exemplary embodiments thereof with reference to the attached drawings in which:

FIGS. 1A and 1B show different tracking polarities depending on a configuration of groove tracks and land tracks;

FIG. 2A shows protruding pits formed on a substrate of an information storage medium according to an embodiment the present invention;

FIG. 2B shows indented pits formed on the substrate of the information storage medium according to an embodiment the present invention;

FIG. 3A is a graph showing the amplitudes of a differential phase detection (DPD) signal and a radio frequency (RF) signal versus time in an information storage medium on which data is formed as protruding pits;

FIG. 3B is a graph showing the amplitudes of a DPD signal and an RF signal versus time in an information storage medium on which data is formed as indented pits;

FIG. 4A is a graph showing a push-pull signal versus time in an information storage medium on which data is formed as protruding pits;

FIG. 4B is a graph showing a push-pull signal versus time in an information storage medium on which data is formed as indented pits;

FIG. 5 shows an example in which tracking polarity data is recorded in a sync pattern on an information storage medium according to an embodiment of the present invention;

FIGS. 6A and 6B show different examples of the location of the information storage medium according to an embodiment of the present invention where tracking polarity information has been recorded in a specific pattern;

FIGS. 7A and 7B show different layouts of an information storage medium according to another embodiment of the present invention;

FIG. 8A schematically shows a structure of an information area of a recordable information storage medium;

FIG. 8B schematically shows a structure of an information area of a reproduction-only information storage medium;

FIG. 9A shows a straight array of pits, and FIG. 9B shows a wobbling array of pits;

FIG. 10 shows an example in which tracking polarity information has been recorded on an information storage medium according to another embodiment of the present invention;

FIGS. 11A and 11B are views illustrating a decoding method based on an exclusive OR (XOR) operation of tracking polarity data and data that is detected from a data frame in the information storage medium according to another embodiment of the present invention;

FIG. 12 is a flowchart illustrating a data recording and/or reproducing method according to another embodiment of the present invention; and

FIG. 13 schematically illustrates an apparatus for recording data in and/or reproducing data from an information storage medium according to the present invention.

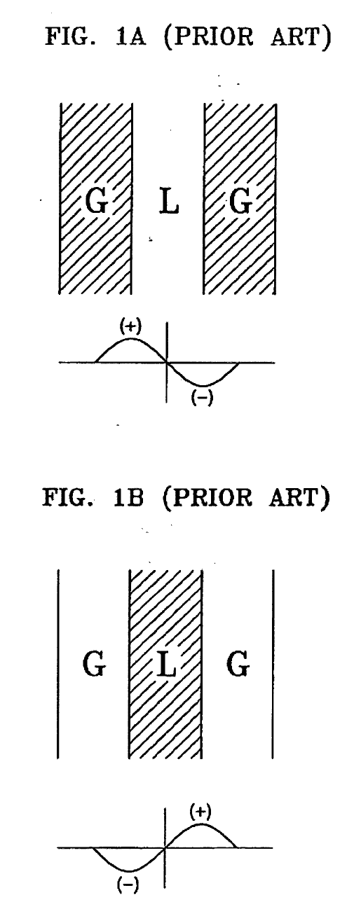

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

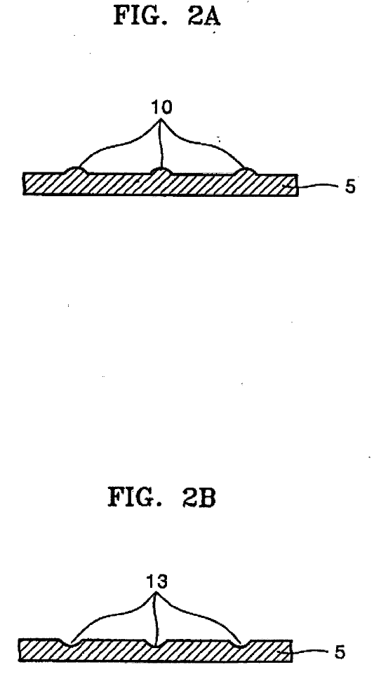

As shown in FIG. 2A, in an optical information storage medium according to an embodiment of the present invention, data is recorded as protruding pits 10 on a substrate 5. Alternatively, as shown in FIG. 2B, data is recorded as indented pits 13 on the substrate 5. Information about the protruding pits 10 or the indented pits 13 is recorded in the optical information storage medium

The information about the protruding or indented pits 10 or 13 may be tracking polarity information.

When data has been recorded in the form of the protruding pits 10, a tracking signal may have a polarity that changes from (+) to (−). When data has been recorded in the form of the indented pits 13, a tracking signal may have a polarity that changes from (−) to (+). As described above, because the polarity of a tracking signal varies depending on the shape of a pit, the tracking signal must be performed differently depending on the pit shape so that data can be normally recorded or reproduced.

The conditions and results of a simulation performed to ascertain the characteristics of a tracking signal are shown in Table 1.

TABLE 1

| | |
|---|---|
| LD wavelength (λ) | 400 nm |
| Numerical aperture of objective lens | 0.85 |
| Groove structure | Track pitch: 0.32 μm |
| Length of minimum mark | 0.149 μm |
| Mark width | 0.15 μm |
| Modulation technique | RLL (1, 7) |

In Table 1, an RLL modulation technique is based on how many bits “0” exist between two bits “1”. RLL (m,k) represents that at least m bits “0” exist between two bits “1” and at most k bits “0” exists therebetween. For example, RLL (1, 7) represents that at least one bit “0” exists between two bits “1” and at most 7 bits “0” exist therebetween. According to the RLL (m, k) modulation technique, when m is 1, data “1010101” is recorded, and a pit with a 2T length exists between two bits “1”. When m is 7, data “10000000100000001” is recorded, and a pit with an 8T length exists between two bits “1”. Here, T denotes the length of a minimum mark, that is, a minimum pit. Hence, in the RLL (1,7) modulation method, data is recorded in the form of pits ranging in length from 2T to 8T and spaces.

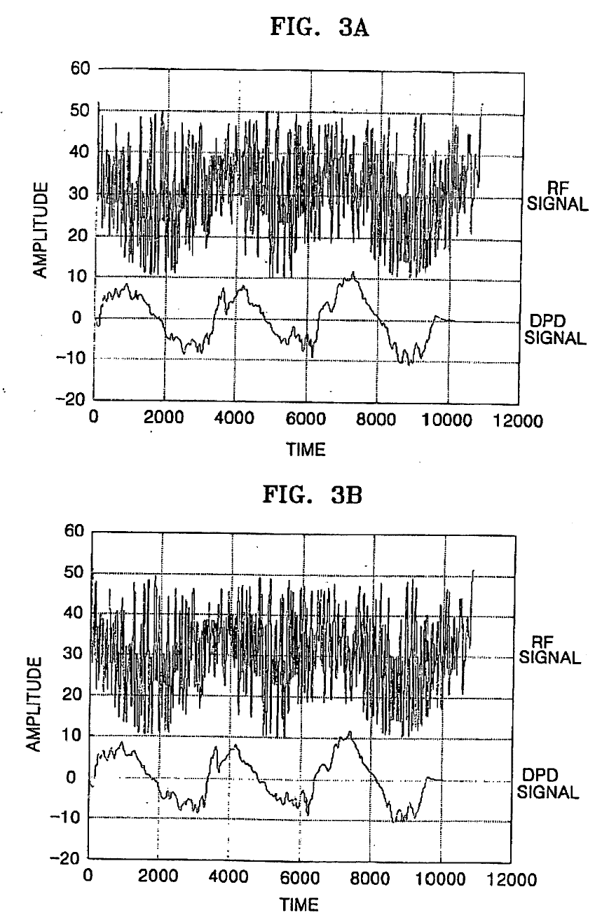

FIG. 3A shows a radio frequency (RF) signal and a differential phase detection (DPD) signal when data has been recorded in the form of the protruding pits 10. FIG. 3B shows an RF signal and a DPD signal when data has been recorded in the form of the indented pits 13. Referring to FIGS. 3A and 3B, the DPD signal does not depend on the shape of a pit.

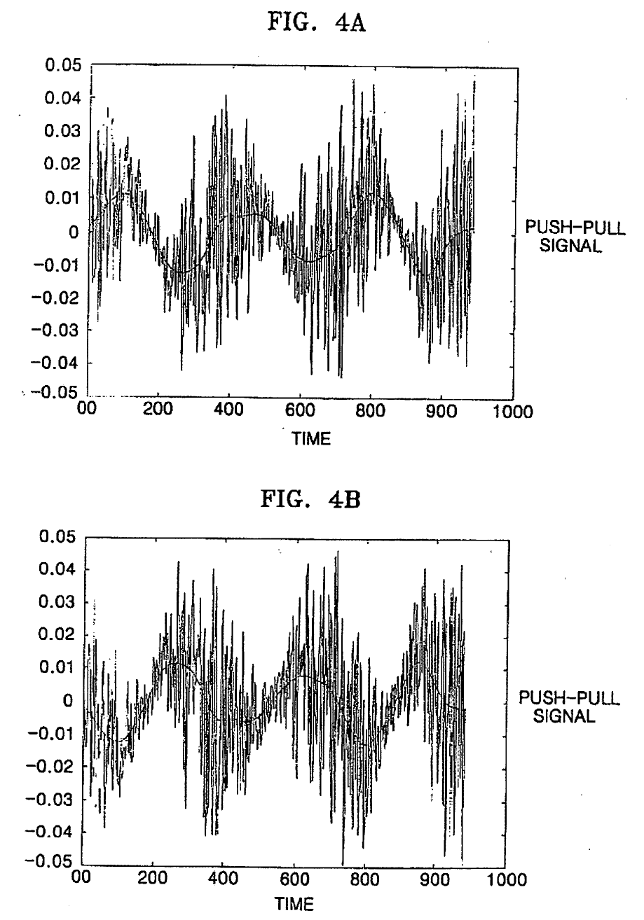

FIG. 4A shows a push-pull signal when data has been recorded in the form of the protruding pits 10, and FIG. 4B shows a push-pull signal when data has been recorded in the form of the indented pits 13. Referring to FIGS. 4A and 4B, the push-pull signal depends on the shape of a pit. Hence, if data is reproduced or tracked using the push-pull signal, information about a tracking polarity depending on a pit shape needs to be recorded. Accordingly, the information about the tracking polarity may be information about the polarity of a push-pull signal.

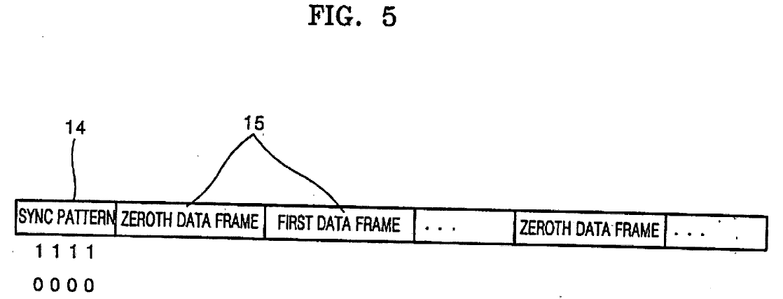

When recording information about a tracking polarity, as shown in FIG. 5, an optical information storage medium according to an embodiment of the present invention includes a plurality of data frames 15, and information about a tracking polarity, that is, push-pull polarity information. The push-pull polarity information can be recorded in a sync pattern on a frame sync 14 included in front of an area including a predetermined number of data frames 15. The sync pattern may be a pattern not used as a user data pattern or a pattern of specific bits. An example of the sync pattern is shown in FIG. 5.

For example, the sync pattern can be formed of a repetition of identical data to represent tracking polarity information. If values “1” are read out consecutively, this means that data is recorded in the form of protruding pits. If values “0” are read out consecutively, this means that data is recorded in the form of indented pits.

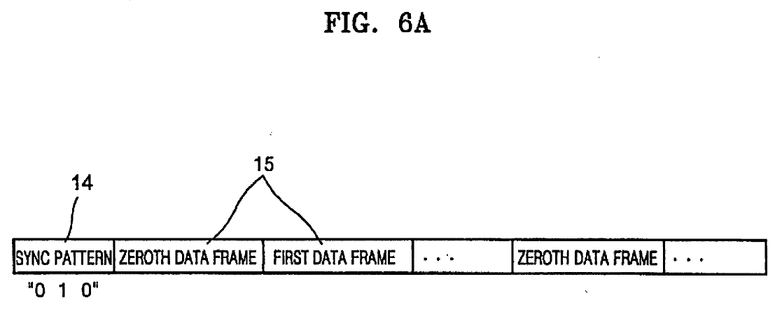

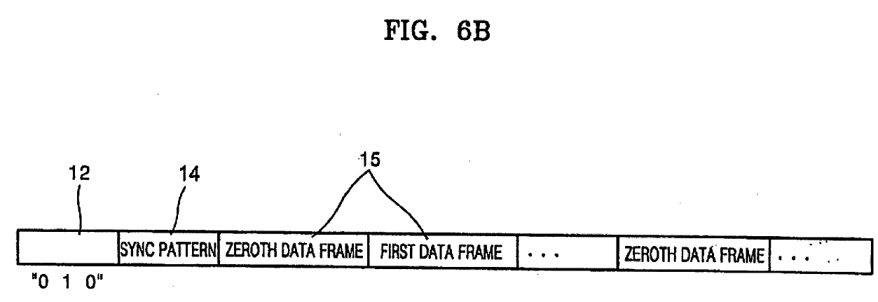

Alternatively, tracking polarity information, that is, push-pull polarity information, may be recorded in a sync pattern of a specific pattern. For example, as shown in FIG. 6A, data “010” is recorded in the frame sync 14 and represents a polarity changing from (+) to (−). In this case, if data “101” is reproduced after tracking, the polarity of a tracking signal is processed conversely so that data can be properly reproduced. In FIG. 6A, the tracking polarity information has been recorded in the frame sync 14. However, as shown in FIG. 6B, the tracking polarity information may be recorded in a predetermined area 12 in front of the frame sync 14. As described above, the tracking polarity information may be recorded in a part of the frame sync 14 or an area other than the frame sync 14.

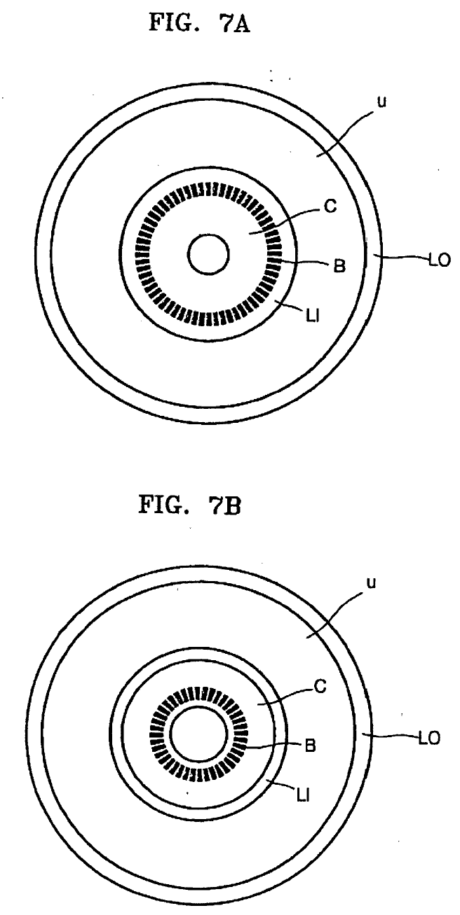

FIGS. 7A and 7B show different layouts of an information storage medium according to another embodiment of the present invention. This information storage medium includes a clamping area C, a burst cutting area (BCA) area B, a lead-in area LI, a user data area U, and a lead-out area LO. The clamping area C denotes an area which is pressed down by a clamping apparatus for clamping a disc.

Tracking polarity information may be recorded in the BCA area B. Unique information about a disc, such as, a serial number, a manufactured day/month/year, and the like, may also be recorded in the BCA area B. In FIG. 7A, the BCA area B is located between the clamping area C and the lead-in area LI. However, as shown in FIG. 7B, the BCA area B may be located in front of the clamping area C.

When tracking polarity information is recorded in the BCA area B, it can be read out before a disc is tracked after the disc is loaded on a drive and focused. Thus, a tracking servo can be efficiently implemented.

The tracking polarity information may also be recorded in the lead-in area LI instead of the BCA area B.

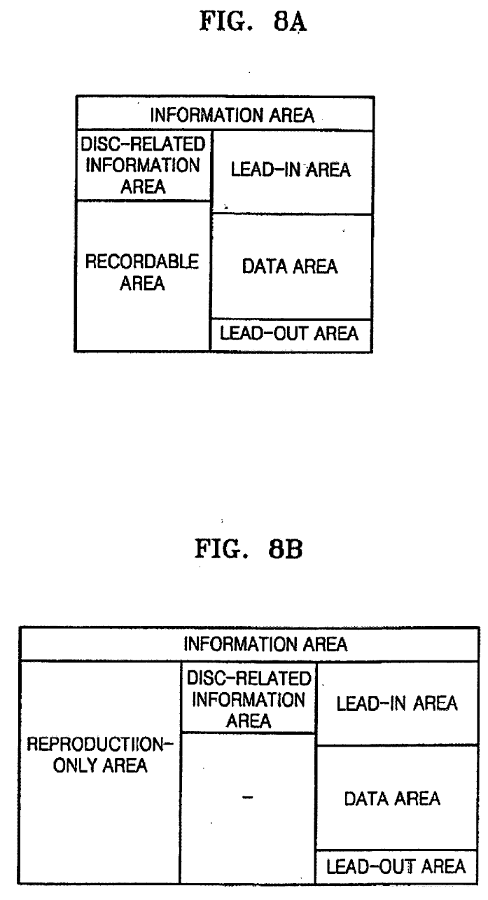

FIG. 8A shows a layout of a recordable information storage medium. Data can be recorded in the form of pits in a part of the recordable information storage medium, for example, in a lead-in area or a lead-out area. Information about the shapes of the pits, that is, tracking polarity information, can be recorded in the lead-in area, preferably, in a disc-related information area.

FIG. 8B shows a layout of a reproduction-only information storage medium. The tracking polarity information can be recorded in a disc-related information area included in a lead-in area. The tracking polarity information includes push-pull polarity information.

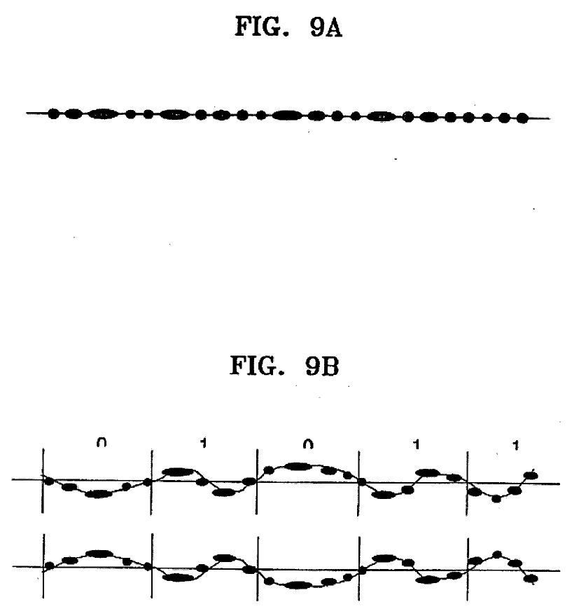

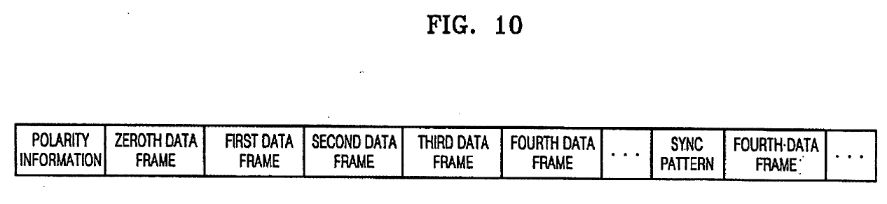

If data is recorded in the form of pits, the pits may be arrayed either in a straight line as shown in FIG. 9A or in a wobbly line as shown in FIG. 9B. When data has been recorded in the form of a straight line of pits, the data recorded in the pits is reproduced using a sum channel, and tracking can be controlled using DPD or the push-pull technique. If tracking is controlled using the push-pull technique, information about a tracking polarity, that is, push-pull polarity information, is required.

When data has been recorded in the form of a wobbly line of pits (hereinafter, referred to as wobbling pits), additional information can be recorded in the wobbles themselves. The data recorded in the wobbling pits is reproduced using a sum channel, and the additional information recorded in the wobbles can be reproduced using a push-pull channel.

Wobbling pits can be arrayed in a single pattern, which is composed of pits each having identical lengths and spaces. In the single pattern of pits, the pits have no data, and instead the wobble may have data. In this case, a push-pull channel may be used as a channel for reproducing data stored in the wobbling pits.

When data is recorded in the form of wobbling pits, it can be recorded using various modulation techniques. For example, data can be recorded using at least one of a phase modulation technique, a frequency modulation technique, and an amplitude modulation technique.

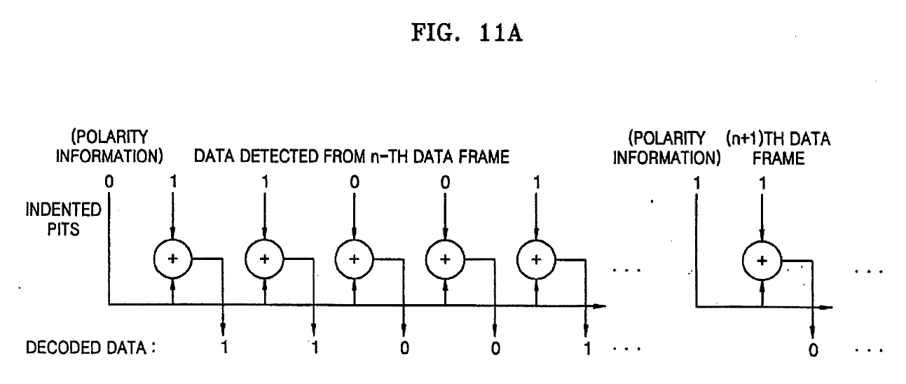

Referring to FIG. 10, in an information storage medium according to another embodiment of the present invention, tracking polarity information is recorded in an area in front of a predetermined data frame, and although data is recorded in different forms, the data in different forms is decoded into identical data by performing an exclusive OR (XOR) operation with respect to the tracking polarity information and data read out with the tracking polarity information. The tracking polarity information may be recorded in a frame sync.

A method of decoding data using an XOR operation when the data has been recorded in the forms of protruding pits or indented pits will now be described. When data recorded in the form of protruding pits is tracked, tracking polarity information is read as, for example, “0”, and data is read as, for example, “11001 . . . ”. When the same data has been recorded in the form of indented pits, tracking polarity information is read as, for example, “1”, and data is read as, for example, “00110 . . . ”.

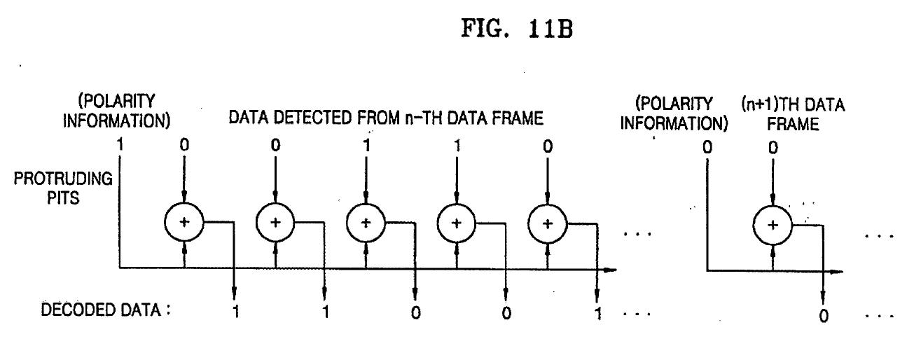

Referring to FIG. 11A, if tracking polarity information regarding indented pits is recorded as data “0”, and data detected from an n-th data frame is “11001 . . . ”, the tracking polarity data and the data detected from the n-th data frame undergo an XOR operation to obtain decoded data “11001 . . . ”.

Referring to FIG. 11B, if tracking polarity information regarding protruding pits is recorded as data “1”, and data detected from an n-th data frame is “00110 . . . ”, the tracking polarity data and the data detected from the n-th data frame undergo an XOR operation to obtain decoded data “11001 . . . ”.

As described above, since data is decoded using an XOR operation with respect to tracking polarity data and data reproduced from pits, data can be properly reproduced and restored regardless of whether the pits are protruding pits or indented pits. Also, decoded data can be obtained without extra change in a controlling operation.

Furthermore, data read out by using tracking polarity information, that is, push-pull polarity information, as a selection signal can be either directly output as decoded data or output as decoded data after the polarity of the data is reversed. In other words, if tracking polarity information is recorded in a predetermined pattern, and read-out tracking polarity information is the same as the predetermined pattern, data is directly decoded. However, if tracking polarity information is recorded in a predetermined pattern, and read-out tracking polarity information is different from the predetermined pattern, data is decoded after its polarity is reversed.

The information storage medium according to the present invention is applicable to multi-layered information storage media with at least two information storage layers as well as to single-layered information storage media.

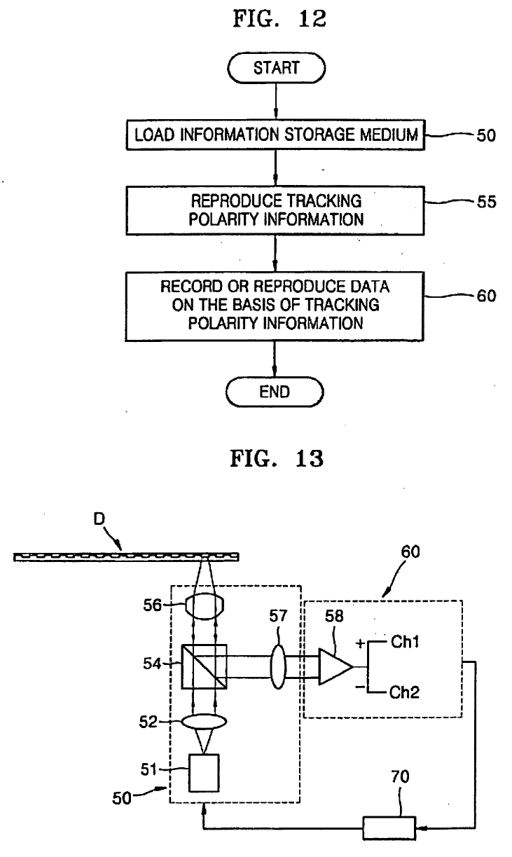

FIG. 12 is a flowchart illustrating a data recording and/or reproducing method according to an embodiment of the present invention. Referring to FIG. 12, in operation 50, an information storage medium is loaded on a disk drive. In operation 55, an optical pickup included in the disk drive reads tracking polarity information, that is, push-pull polarity information, from the loaded information storage medium. The tracking polarity information is recorded as in the embodiments described above and used as a basis on which a tracking signal is detected or data is recorded and/or reproduced.

Because a tracking polarity varies depending on the protruding pits 10 of FIG. 2A or the indented pits 13 of FIG. 2B, a tracking signal is differently processed according to tracking polarity information. If tracking polarity information is recorded in the BCA area B, an information storage medium is first loaded on a disk drive, and then focusing control is achieved, and the tracking polarity information is read from the BCA area B before data is read from the loaded information storage medium. Thus, tracking control and information reproduction are reliable.

In operation 60, the disk drive records data on or reproduces data from a data area by performing tracking control without trials and errors on the basis of the reproduced tracking polarity information, that is, push-pull polarity information. In other words, the optical pickup provides the reproduced tracking polarity information to the disk drive, and the disk drive controls the optical pickup on the basis of the received information so that data is smoothly recorded on or reproduced from the information storage medium.

Data can be decoded by performing an XOR operation with respect to tracking polarity data and data reproduced from pits. Thus, data can be decoded regardless of a tracking polarity.

Data reproduced on the basis of the tracking polarity information may be either directly output as decoded data or output as decoded data after its polarity is reversed. In other words, if tracking polarity information is recorded in a predetermined pattern, and read-out tracking polarity information is the same as the predetermined pattern, data is directly decoded. On the other hand, if tracking polarity information is recorded in a predetermined pattern, and read-out tracking polarity information is different from the predetermined pattern, data is decoded after its polarity is reversed.

FIG. 13 schematically illustrates an apparatus for recording data in and/or reproducing data from an information storage medium according to the present invention. The apparatus includes a pickup 50, a recording/reproducing signal processor 60, and a controller 70. More specifically, the pickup 50 includes a laser diode 51 for radiating light, a collimating lens 52 for collimating the light emitted by the laser diode 51, a beam splitter 54 for changing a path of incident light, and an objective lens 56 for focusing light passed through the beam splitter 54 on an information storage medium D.

Light reflected from the information storage medium D is reflected by the beam splitter 54 and received by a photodetector, for example, a 4-divisional photodetector 57. The light incident upon the 4-divisional photodetector 57 is converted into an electrical signal while passing through an operational circuit 58. An RF signal, that is, a sum signal is output via a first channel Ch1 and a differential signal used in a push-pull technique via a second channel Ch 2.

When the information storage medium D is loaded, the controller 70 controls the pickup 50 to project a beam onto the information storage medium D and reads out a signal into which a beam reflected by the information storage medium D is converted by the signal processor 60. More specifically, the beam reflected by the information storage medium D is applied to the photodetector 57 via the objective lens 56 and the beam splitter 54. The beam incident upon the photodetector 57 is converted into an electrical signal by the operational circuit 58, and the electrical signal is output as an RF signal.

The signal processor 60 processes a data signal according to tracking polarity information read out from the information storage medium D. The controller 70 controls the pickup 50 based on the data signal processed by the signal processor 60.

As described above, in an information storage medium according to the present invention, tracking polarity information (i.e., push-pull polarity information) with respect to protruding pits and indented pits is recorded so that data can be reliably recorded or reproduced without trials and errors for obtaining tracking polarity information. Also, if data is recorded in the form of pits, each of the pits may have various shapes, like, indented or protruding pits.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. An apparatus for reproducing data recorded on an information storage medium having at least one information storage layer, the apparatus comprising:
a pickup projecting a beam onto the information storage medium in which the data is recorded in form of protruding or indented pits in an entire or partial area of the information storage medium;
a reproduction signal processor reproducing tracking polarity information regarding the protruding or indented pits recorded at the entire or partial area of the information storage medium; and
a controller controlling the pickup based on the tracking polarity information processed by the reproduction signal processor.

2. The apparatus of claim 1, further comprising a sum channel and a push-pull channel reproducing the data recorded in form of the protruding or indented pits.

3. The apparatus of claim 1, wherein the reproduction signal processor reproduces the data recorded in the form of protruding or indented pits from a frame sync or from in front of the frame sync.

4. The apparatus of claim 1, wherein the tracking polarity information processed by the reproduction signal processor is push-pull polarity information.

5. The apparatus of claim 4, wherein the reproduction signal processor reproduces the data from the protruding or indented pits and either directly outputs the data or outputs the data after a polarity of the data is reversed, according to the push-pull polarity information.

6. The apparatus of claim 4, wherein the reproduction signal processor decodes the data by performing an exclusive OR operation with respect to the push-pull polarity information and the data reproduced from the protruding or indented pits.

7. The apparatus of claim 1, wherein the reproduction signal processor decodes the data using an XOR operation with respect to the tracking polarity information and the data reproduced from the pits.

8. An apparatus for reproducing data recorded on an information storage medium, the apparatus comprising:
a pickup projecting a beam onto an information storage medium in which information regarding protruding or indented pits is recorded as push-pull polarity information;
a reproduction signal processor processing a data signal based on the push-pull polarity information received from the pickup; and
a controller controlling the pickup based on the data signal processed by the reproduction signal processor.
